(19) United States
(12) Patent Application Publication
(10) Pub. No.: US 2015/0308892 A1
(43) Pub. Date: Oct. 29, 2015

(54) Impulsive synchronization spectrometer based on adjustable time window

(71) Applicant: Sichuan University, Chengdu (CN)

(72) Inventors: Guoying Feng, Chengdu (CN); Ke Yao, Chengdu (CN); Hong Zhang, Chengdu (CN); Shouhuan Zhou, Chengdu (CN)

(73) Assignee: Sichuan University

(21) Appl. No.: 14/790,483

(22) Filed: Jul. 2, 2015

(30) Foreign Application Priority Data
Dec. 10, 2014 (CN) 201410756105.X

(51) Int. Cl. G01J 3/02; G01J 3/28

(52) U.S. Cl. CPC G01J 3/027; G01J 3/0224; G01J 3/28

(57) ABSTRACT

An impulsive synchronization spectrometer based on adjustable time window, includes a synchronous controller, a pulse light source, a high speed collection card, a computer system, a first photoelectric detector, a second photoelectric detector and a testing optical path system; wherein the synchronous controller has four output terminals. The first output terminal is connected with the pulse light source; and the second output terminal is connected with a computer; the third output terminal and the fourth output terminal are respectively connected with two channels of the high speed collection card and respectively output two-channel signals of a third synchronous signal and a fourth synchronous signal respectively serving as external triggering signals of the two channels to control signals in the two channels of the high speed collection card, the first photoelectric detector and the second photoelectric detector are respectively connected with the two channels of the high speed collection card.

### CROSS REFERENCE OF RELATED APPLICATION

The present application claims priority under 35 U.S.C. 119(a-d) to CN 201410756105.X, filed Dec. 10, 2014.

### BACKGROUND OF THE PRESENT INVENTION

1. Field of Invention

The present invention relates to the field of the spectral properties measurement technique, and more particularly to an impulsive synchronization spectrometer based on adjustable time window.

2. Description of Related Arts

Spectral measurement technology, which is a commonly used characterization and diagnosis technique, has been widely utilized in various fields of optics, material science, biochemistry, medical science and etc. With the development of laser techniques, various short pulse lasers and the corresponding applications are increasingly mature. However, spectral measurement on the pulsed light signals generated by the short pulse laser and t exciting material with short pulse laser is still an issue requiring for further research, including spectral composition analysis, time characteristic curve analysis, polarization state analysis and etc.

The common spectral measurement method is a wavelength scanning method. The wavelength scanning method is only capable of measuring a single wavelength each time. Thus, a splitting element is often rotated, in such a manner that the detector receives light waves having different wave lengths during the process of rotation, so that the spectral component of the optical pulse is recorded, and the scanning measurement of the spectrum is achieved. The method has benefits of low cost, high precision, good performance of anti-noise and anti-fluctuation, high light stability, but disadvantages of low efficiency and requiring for relatively steady optical pulse outputted. Furthermore, the key of this spectral measurement technique is a synchronization measure technique. The synchronization measure technique is often adopting a phase locking technique which is a feedback control technique for synchronizing a clock outputted with an external reference clock. When the frequency or the phase of the reference clock varies, the phase locking device detects the variation and regulates the output frequency by a feedback system therein until the output clock of the circuit synchronizes with the external reference clock. The lock-in amplifier is a typical device for collecting pulse signals utilizing phase locking technique and is widely adopted in the field of synchronous measurement. The principle of the lock-in amplifier is obtaining useful synchronous pulse signal by the synchronous technique, and then performing integration on synchronous pulse signals at a certain time interval to extract the signal intensity. This method is suitable for signals having a long pulse width, but difficult to be applied in collecting signals with short pulse width. That's because the minimum time constant of the lock-in amplifier is at a microsecond distribution or above. For the pulse signal having a pulse width of a microsecond distribution or above, all or most of the useful synchronous signals can always be collected in the time intervals of the integration. However, for the pulse signal having a pulse width of a nanosecond distribution or below, a long integration time will result in the pulse signal to be smooth and thus a serious distortion appears. If the integration time is short, the useful signals are not capable of being collected at all because the lock-in amplifier doesn't have the sequence chart function of the delay adjustable and visual signals. For the low PRF (Pulse Repetition Frequency) short pulse signal, since the duty cycle of the pulse is very small, collection of the signal is more difficult, this leads to a result that the conventional spectrum measuring instruments are not capable of collecting signals. The issues mentioned above make the spectral properties measurement a difficult problem and greatly hinder the application of the pulse light source.

### SUMMARY OF THE PRESENT INVENTION

In view of the disadvantages in the conventional art, an object of the present invention is to provide an impulsive synchronization spectrometer based on adjustable time window which is capable of accurately measuring a low PRF (Pulse Repetition Frequency) light pulse signal with a wide spectral range and a wide pulse width range.

An impulsive synchronization spectrometer based on adjustable time window, comprises: a synchronous controller, a pulse light source, a high speed collection card, a computer system, a first photoelectric detector, a second photoelectric detector and a testing optical path system;

wherein the synchronous controller has four output terminals which are a first output terminal, a second output terminal, a third output terminal and a fourth output terminal, which respectively output four-channel signals synchronously, a delay exists between each channel of synchronous signals;

wherein the first output terminal is connected with the pulse light source and outputs a first synchronous signal for serving as an external triggering signal of the pulse light source to control output of optical pulse;

the second output terminal is connected with a computer and outputs a second synchronous signal for informing the computer system to read data from the high speed collection card;

the third output terminal and the fourth output terminal are respectively connected with two channels of the high speed collection card and respectively output two-channel signals which are a third synchronous signal and a fourth synchronous signal respectively serving as external triggering signals of the two channels to control signals in the two channels of the high speed collection card, and collection time is pulse width of the third synchronous signal and the fourth synchronous signal;

the first photoelectric detector and the second photoelectric detector are respectively connected with the two channels of the high speed collection card;

constitution of the testing optical path system is: pulsed light emitted by the pulse light source is reflected by a reflector to change propagation direction, passes through a polarizing film and then is incident to a beam splitter to be splitted into a first pulsed light and a second pulsed light, and the first pulsed light serves as a reference light and the second pulsed light serves as a useful signal light,

the reference light is vertically incident to the first photoelectric detector to be converted into a reference signal;

the useful signal light passes through a lens on a same circuit and to be gathered, and then passes through an entrance slit, a second reflector to be incident to a grating group which is provided on a turnplate to be reflected, and then passes through a third reflector and an exit slit to access a second photoelectric detector to be converted to useful signals.

The high speed collection card accomplishes collecting the reference signal and the useful signal under the control of two channel synchronous signals. While receives a corresponding synchronous signal, the computer sends a command to the high speed collection card, reads and processes data to obtain spectral properties of a single wavelength, and then controls testing optical path to output light with a next wavelength. The processes mentioned above are repeated to accomplish measuring whole spectral properties of the optical pulse.

In the impulsive synchronization spectrometer based on adjustable time window, the pulse width and frequency of the synchronous signals are adjustable, and delays between the synchronous signals are adjustable, and a minimum value of the delays is one nanosecond.

In the impulsive synchronization spectrometer based on adjustable time window, the pulse light source is a pulse laser source, a nonlinear laser source excited by a pulse laser pump or pulse light excited by an electrical pump, wherein pulse width of the pulse light source is at a level of sub-nanosecond, nanosecond, microsecond or millisecond, and a highest repetition frequency is 1 kHz.

In the impulsive synchronization spectrometer based on adjustable time window, the high speed collection card is capable of collecting electric signals with a pulse width at a level of a sun-nanosecond or above.

In the impulsive synchronization spectrometer based on adjustable time window, the grating group comprises a plurality of gratings, the grating group is integrated on a turn table, each grating has different range of spectral wavelength, optical wavelength is controlled and the splitting element is selected by rotating a control detector via the turn table.

In the impulsive synchronization spectrometer based on adjustable time window, width of the incident slit and the exit slit are adjustable.

In the impulsive synchronization spectrometer based on adjustable time window, the first photoelectric detector and the second photoelectric detector are a photomultiplier, an InTE detector or a MCT detector, and a response time of the first photoelectric detector and the second photoelectric detector is less than the width of the pulse signal.

Compared with the conventional art, the present invention has the following beneficial effects.

1. The impulsive synchronization spectrometer based on adjustable time window is capable of precisely measuring a great range of light pulse, wherein a minimum measurable pulse width is a sub-nanosecond pulse, and a maximum measurable pulse width is capable of reaching a level of millisecond or a second level, which accomplishes measuring a repetition-rate light pulse signal. However, a minimum measurable pulse width of the conventional spectral measurement technology based on wavelength scanning is at a level of microsecond or sub-microsecond.

2. In the impulsive synchronization spectrometer based on adjustable time window, the light pulse is classified into reference light and useful signal light, and two detectors are utilized to detect a reference signal and a useful signal. The reference signal is capable of representing fluctuation characteristics of a range of the light pulse in real time. The useful signal represents spectral properties of the light pulse at a single wavelength. The reference signal is utilized for revising the spectral properties obtained (See Embodiment 2), so as to obtain accurate spectral component information. The present invention is capable of accurately measuring spectral properties under a condition that the light pulse signal is not stable, which is capable of greatly relieving the requirement for the stability of a light source system of a conventional spectrum measuring instrument based on wavelength scanning method, and thus solves the problem of over-reliance of stability based on a wavelength scanning method.

3. Compared with the conventional spectral measurement technique, the impulsive synchronization spectrometer based on adjustable time window of the present invention introduces a high precision controllable synchronous pulse, and thus is capable of adjusting delays among synchronous signals. A minimum delay precision is 1-2 nanosecond. In addition, a visible sequence chart interface among each signal is provided, so the useful signal is precisely controlled in an integration signal by a fine adjustment of delays, so as to ensure that the signals can be collected accurately.

4. Compared with the conventional spectrum measuring instrument based on the wavelength scanning method, the impulsive synchronization spectrometer based on adjustable time window of the present invention integrates functions of measuring spectral component and light wave time properties, and is capable of representing spectral properties of the light pulse.

5. The impulsive synchronization spectrometer based on adjustable time window of the present invention adopts a wavelength scanning method and integration method, thus the whole system has advantages of low costs, good anti-noise performance and high precision and sensitivity, and is suitable for detecting various light pulses.

6. In the impulsive synchronization spectrometer based on adjustable time window of the present invention, a plurality of splitting elements are integrated on a turnplate. Suitable splitting elements are selected by rotating the turnplate, so as to achieve spectral measurement of a wide wavelength, and the measurable wave band is from violet, visible, near-infrared to intermediate infrared wavelength.

### BRIEF DESCRIPTION OF THE DRAWINGS

FIG. 1 is a structural schematic view of an impulsive synchronization spectrometer based on adjustable time window according to a preferred embodiment of the present invention.

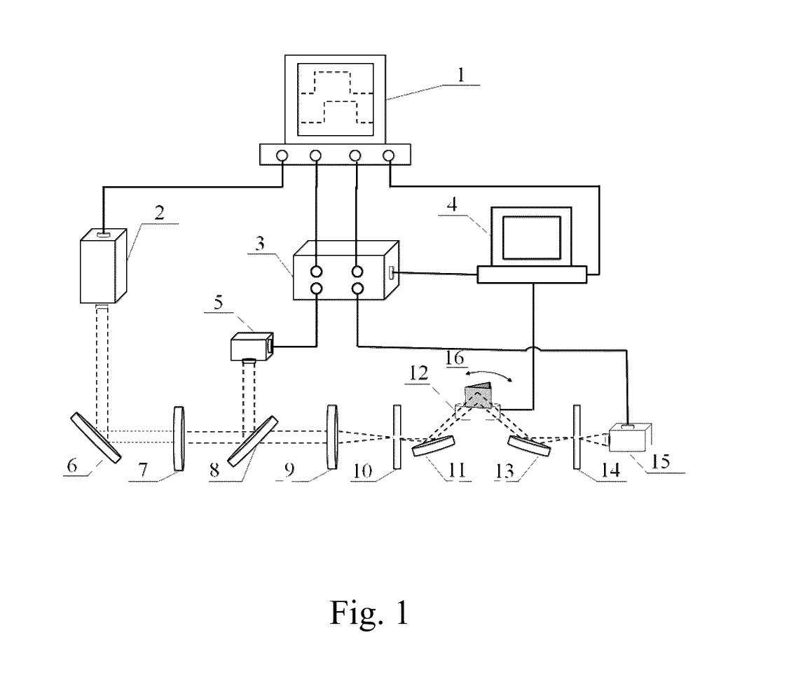

FIG. 2 is a sequence chart of a synchronous controller of the present invention.

FIG. 3 is a testing flow chart of the impulsive synchronization spectrometer based on adjustable time window according to the preferred embodiment of the present invention.

In the drawings, 1—synchronous controller; 2—pulse light source; 3—high speed collection card; 4—computer system; 5—first photoelectric detector; 6—second photoelectric detector; 7—polarizer; 8—beam splitter; 9—lens; 10—incident slit; 11—second reflector; 12—turn table; 13—third reflector; 14—exit slit; 15—second photoelectric detector; 16—grating group.

### DETAILED DESCRIPTION OF THE PREFERRED EMBODIMENT

These and other objectives, features, and advantages of the present invention will become apparent from the following detailed description, the accompanying drawings, and the appended claims.

One skilled in the art will understand that the embodiment of the present invention as shown in the drawings and described above is exemplary only and not intended to be limiting.

### Embodiment 1

An impulsive synchronization spectrometer based on adjustable time window according to a preferred embodiment of the present invention, comprises: a synchronous controller 1, a pulse light source 2 (with a pulse width of approximately 125 nanosecond, a repetition frequency of 1 Hz), a high speed collection card 3 which is capable of collecting electric signals at a level of nanosecond or above, a computer system 4, a first photoelectric detector 5, a second photoelectric detector 15 and a testing optical path system.

Preferably, pulse width and frequency of the synchronous signals and delays between the synchronous signals are adjustable, and a minimum value of the delays is one nanosecond.

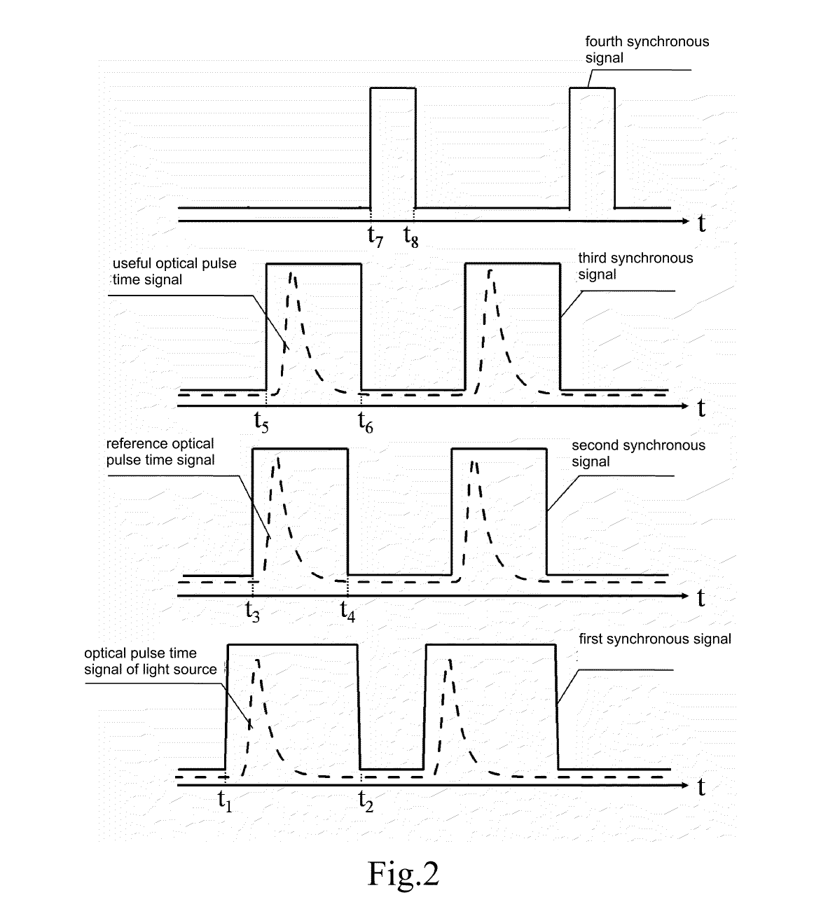

The synchronous controller 1 has four output terminals which are a first output terminal, a second output terminal, a third output terminal and a fourth output terminal, which respectively output a sequence chart as shown in FIG. 2 of the drawings, and output four-channel signals respectively at times of t₁, t₃, t₅ and t₇, a delay exists between each channel of synchronous signals;

wherein the first output terminal is connected with the pulse light source 2 and outputs a first synchronous signal for serving as an external triggering signal of the pulse light source 2 to control the pulse laser source to output an optical pulse;

the fourth output terminal is connected with a computer and outputs a fourth synchronous signal for informing the computer system 4 to read data of the high speed collection card 3 and read width information of optical pulse from the synchronous controller;

the second output terminal and the third output terminal of the synchronous controller are respectively connected with two channels of the high speed collection card 3 and respectively output two-channel signals which are a second synchronous signal and a third synchronous signal respectively serving as external triggering signals of the two channels to control signals in the two channels of the high speed collection card 3, and collection time is pulse width of the third synchronous signal and the fourth synchronous signal;

the first photoelectric detector 5 and the second photoelectric detector 15 are respectively connected with the two channels of the high speed collection card.

Constitution of the testing optical path system is: pulsed light emitted by the pulse light source 2 is reflected by a reflector 6 to change propagation direction, passes through a polarizing film 7 and then is incident to a beam splitter 8 to be splitted into a first pulsed light and a second pulsed light, and the first pulsed light serves as a reference light and the second pulsed light serves as a useful signal light, the reference light is vertically incident to the first photoelectric detector 5 to be converted into a reference signal;

the useful signal light passes through a lens on a same circuit and to be gathered, and then passes through an entrance slit 10, a second reflector 11 to be incident to a grating group 16 which is provided on a turnplate 12 to be reflected, and then passes through a third reflector 13 and an exit slit 14 to access a second photoelectric detector 15 to be converted to useful signals.

The reference signals and the useful signals are sent to the high speed collection card 3, the reference signals and the useful signals are extracted under a precise control of the second synchronous signal and the third synchronous signal, and then are sent to the computer system 4 for processing, so as to obtain spectral properties of a single wavelength. The computer system controls the turnplate 12 to control grating spectral wavelength. The steps mentioned above are repeated to obtain spectral properties at a range of a whole wavelength.

The grating group comprises a plurality of gratings, the grating group is integrated on a turn table, each grating has different range of spectral wavelength, optical wavelength is controlled and the gratings are selected by rotating a control detector via the turn table. Widths of the incident slit 10 and the exit slit 14 are adjustable.

### Embodiment 2

Spectral properties of pulse outputted by Er²⁺:YAG laser device having a wavelength of 2.94 μm, a pulse width of 150 ns, a repetition frequency. A transmissivity to a reflectivity of the beam splitter 8 to the wavelength is 1:9. The first detector 5 adopts an energy meter, and a focal length of the lens 9 is 10 cm. The first reflector 6, the second reflector 11 and the third reflector 13 all have a reflectivity of over 90% to laser with a wavelength of 2.94 μm. The splitting element adopts a 120 g/mm grating with a blaze wavelength of 2.5 μm. The second detector is a MCT detector, and a response time thereof is approximately 50 ns. Time sequence of each synchronous signal is precisely controlled by a synchronous controller. As shown in FIG. 2, a delay between the third synchronous signal and the first synchronous signal is 150 μs.

The method is as follows.

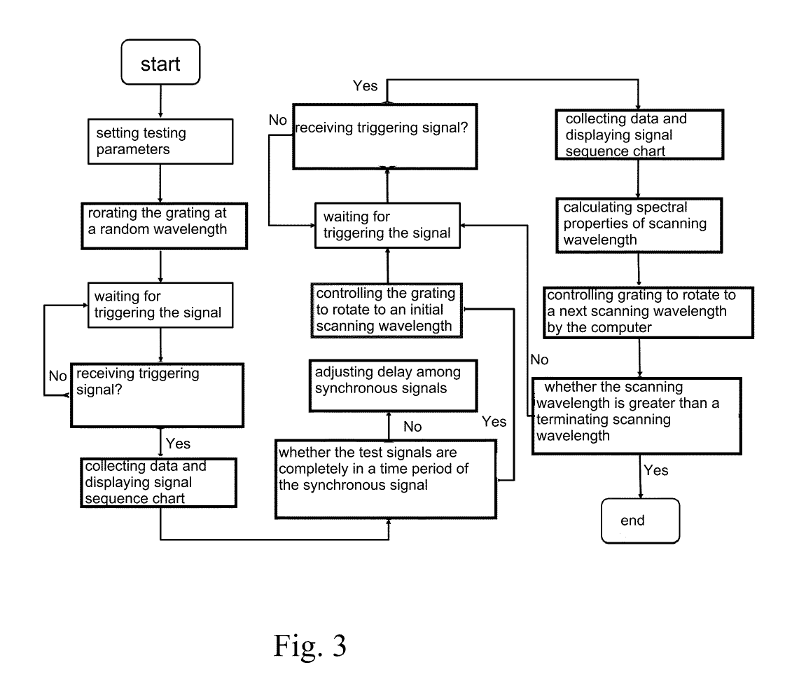

Referring to the flow chart in FIG. 3, after the hardware system is connected and set, the method comprises steps of:

Step 1: rotating a grating at a position of 2.94 μm by a computer system;

Step 2: waiting for triggering signals, wherein after the signals are triggered, a computer system reads a reference signal, a useful signals, a second synchronous signal and a third synchronous signal from a high speed collection card, so as to obtain a signal sequence chart which is displayed on a software interface;

Step 3: observing time positions of the reference signal, the useful signal and the synchronous signal on the interface of the sequence chart, wherein if the reference signal and the useful signal are not respectively positioned in the second synchronous signal and the third synchronous signal, a step 4 is performed;

Step 4: according to the sequence chart, making a feedback and controlling delays between each synchronous signal outputted by a synchronous controller, and repeating the steps 2-4 until the reference signal and the useful signal are respectively in a time period of the second synchronous signal and the third synchronous signal;

Step 5: rotating the grating at a scanning wavelength by the computer system and repeating the step 2;

Step 6: processing integration on the reference signal and the useful signal respectively in the time period of the second synchronous signal and the third synchronous signal, so as to obtain spectral properties at a single wavelength; and

Step 7: controlling a spectral module to rotate to a next scanning wavelength by a computer system, and judging that whether scanning the wavelength is finished, wherein if yes, terminate the measuring process; if no, repeat the steps 4-6 until the measuring process is finished.

A method of modifying light intensity of optical signals is as follows.

According to the sequence chart in the FIG. 2, time property of a kth pulse in optical pulse sequence is denoted as f_{source}(t−t₁,Δtₖ,k), light intensity of the reference signal and the useful signal are respectively denoted as:

$${I}_{reference} ( k , {λ}_{k} ) = α {\int }_{{t}_{3}}^{{t}_{4}} {f}_{source} ( t - {t}_{3} , Δ {t}_{k} , k ) d t \qquad ( 1 )$$

wherein λₖ represents a measured wavelength of a kth pulse and is determined by an angle of the turnplate;

t represents time, Δtₖ represents a time pulse width of the kth pulse;

α represents energy ratio of reflected optical pulse after passing through the beam splitter for serving as a reference light;

β represents detection efficiency of useful signal light;

t₃ and t₄ respectively represent a rising time and a falling time of the second synchronous signal; and

t₅ and t₆ respectively represent a rising time and a falling time of the third synchronous signal.

In order to eliminate changes of light intensity of a measurement result, light intensity of effective signals is revised utilizing energy of the reference light, so as to obtain a revised actual light intensity which is represented as:

$${I}_{real} ( k , {λ}_{k} ) = \frac{{I}_{signal} ( k , {λ}_{k} )}{{I}_{reference} ( k , {λ}_{k} )} = \frac{( 1 - α ) β {\int }_{{t}_{5}}^{{t}_{6}} {f}_{source} ( t - {t}_{5} , Δ {t}_{k} , k ) d t}{α {\int }_{{t}_{3}}^{{t}_{4}} {f}_{source} ( t - {t}_{3} , Δ {t}_{k} , k ) d t} \qquad ( 3 )$$

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An impulsive synchronization spectrometer based on adjustable time window, comprising: a synchronous controller (1), a pulse light source (2), a high speed collection card (3), a computer system (4), a first photoelectric detector (5), a second photoelectric detector (15) and a testing optical path system;
wherein the synchronous controller (1) has four output terminals which are a first output terminal, a second output terminal, a third output terminal and a fourth output terminal, which respectively output four-channel signals synchronously, a delay exists between each channel of synchronous signals;
wherein the first output terminal is connected with the pulse light source (2) and outputs a first synchronous signal for serving as an external triggering signal of the pulse light source (2) to control output of optical pulse;
the fourth output terminal is connected with a computer and outputs a fourth synchronous signal for informing the computer system (4) to read data of the high speed collection card (3);
the second output terminal and the third output terminal are respectively connected with two channels of the high speed collection card (3) and respectively output two-channel signals which are a second synchronous signal and a third synchronous signal respectively serving as external triggering signals of the two channels to control signals in the two channels of the high speed collection card (3), and collection time is pulse width of the second synchronous signal and the third synchronous signal;
the first photoelectric detector (5) and the second photoelectric detector (15) are respectively connected with the two channels of the high speed collection card;
constitution of the testing optical path system is: pulsed light emitted by the pulse light source (2) is reflected by a reflector (6) to change propagation direction, passes through a polarizing film (7) and then is incident to a beam splitter (8) to be splitted into a first pulsed light and a second pulsed light, and the first pulsed light serves as a reference light and the second pulsed light serves as a useful signal light,
the reference light is vertically incident to the first photoelectric detector (5) to be converted into a reference signal;
the useful signal light passes through a lens on a same circuit and to be gathered, and then passes through an entrance slit (10), a second reflector (11) to be incident to a grating group (16) which is provided on a turnplate (12) to be reflected, and then passes through a third reflector (13) and an exit slit (14) to access a second photoelectric detector (15) to be converted to useful signals.

2. The impulsive synchronization spectrometer based on adjustable time window, as recited in claim 1, wherein pulse width and frequency of the synchronous signals are adjustable, and delays between the synchronous signals are adjustable, and a minimum value of the delays is one nanosecond.

3. The impulsive synchronization spectrometer based on adjustable time window, as recited in claim 1, wherein the pulse light source is a pulse laser source, a nonlinear laser source excited by a pulse laser pump or pulse light excited by an electrical pump, wherein pulse width of the pulse light source is at a level of sub-nanosecond, nanosecond, microsecond or millisecond, and a highest repetition frequency is 1 kHz.

4. The impulsive synchronization spectrometer based on adjustable time window, as recited in claim 2, wherein the pulse light source is a pulse laser source, a nonlinear laser source excited by a pulse laser pump or pulse light excited by an electrical pump, wherein pulse width of the pulse light source is at a level of sub-nanosecond, nanosecond, microsecond or millisecond, and a highest repetition frequency is 1 kHz.

5. The impulsive synchronization spectrometer based on adjustable time window, as recited in claim 1, wherein the high speed collection card is capable of collecting electric signals with a pulse width at a level of a sun-nanosecond or above.

6. The impulsive synchronization spectrometer based on adjustable time window, as recited in claim 2, wherein the high speed collection card is capable of collecting electric signals with a pulse width at a level of a sun-nanosecond or above.

7. The impulsive synchronization spectrometer based on adjustable time window, as recited in claim 3, wherein the high speed collection card is capable of collecting electric signals with a pulse width at a level of a sun-nanosecond or above.

8. The impulsive synchronization spectrometer based on adjustable time window, as recited in claim 4, wherein the high speed collection card is capable of collecting electric signals with a pulse width at a level of a sun-nanosecond or above.

9. The impulsive synchronization spectrometer based on adjustable time window, as recited in claim 1, wherein the grating group comprises a plurality of gratings, the grating group is integrated on a turn table, each grating has different range of spectral wavelength, optical wavelength is controlled and the gratings are selected by rotating a control detector via the turn table.

10. The impulsive synchronization spectrometer based on adjustable time window, as recited in claim 2, wherein the grating group comprises a plurality of gratings, the grating group is integrated on a turn table, each grating has different range of spectral wavelength, optical wavelength is controlled and the gratings are selected by rotating a control detector via the turn table.

11. The impulsive synchronization spectrometer based on adjustable time window, as recited in claim 3, wherein the grating group comprises a plurality of gratings, the grating group is integrated on a turn table, each grating has different range of spectral wavelength, optical wavelength is controlled and the gratings are selected by rotating a control detector via the turn table.

12. The impulsive synchronization spectrometer based on adjustable time window, as recited in claim 4, wherein the grating group comprises a plurality of gratings, the grating group is integrated on a turn table, each grating has different range of spectral wavelength, optical wavelength is controlled and the gratings are selected by rotating a control detector via the turn table.

13. The impulsive synchronization spectrometer based on adjustable time window, as recited in claim 5, wherein the grating group comprises a plurality of gratings, the grating group is integrated on a turn table, each grating has different range of spectral wavelength, optical wavelength is controlled and the gratings are selected by rotating a control detector via the turn table.

14. The impulsive synchronization spectrometer based on adjustable time window, as recited in claim 6, wherein the grating group comprises a plurality of gratings, the grating group is integrated on a turn table, each grating has different range of spectral wavelength, optical wavelength is controlled and the gratings are selected by rotating a control detector via the turn table.

15. The impulsive synchronization spectrometer based on adjustable time window, as recited in claim 7, wherein the grating group comprises a plurality of gratings, the grating group is integrated on a turn table, each grating has different range of spectral wavelength, optical wavelength is controlled and the gratings are selected by rotating a control detector via the turn table.

16. The impulsive synchronization spectrometer based on adjustable time window, as recited in claim 8, wherein the grating group comprises a plurality of gratings, the grating group is integrated on a turn table, each grating has different range of spectral wavelength, optical wavelength is controlled and the gratings are selected by rotating a control detector via the turn table.

17. The impulsive synchronization spectrometer based on adjustable time window, as recited in claim 1, wherein width of the incident slit (10) and the exit slit (14) are adjustable.

18. The impulsive synchronization spectrometer based on adjustable time window, as recited in claim 2, wherein width of the incident slit (10) and the exit slit (14) are adjustable.

19. The impulsive synchronization spectrometer based on adjustable time window, as recited in claim 1, wherein the first photoelectric detector and the second photoelectric detector are a photomultiplier, an InTE detector or a MCT detector, and a response time of the first photoelectric detector and the second photoelectric detector is less than the width of the pulse signal.

20. The impulsive synchronization spectrometer based on adjustable time window, as recited in claim 2, wherein the first photoelectric detector and the second photoelectric detector are a photomultiplier, an InTE detector or a MCT detector, and a response time of the first photoelectric detector and the second photoelectric detector is less than the width of the pulse signal.
